(19) United States
(12) Patent Application Publication
(10) Pub. No.: US 2024/0011576 A1
(43) Pub. Date: Jan. 11, 2024

(54) CONTROL VALVE FOR CONTROLLING A GAS THROUGH-FLOW

(71) Applicant: Binder GmbH, Ulm (DE)

(72) Inventor: Robert Binder, Laichingen (DE)

(21) Appl. No.: 18/371,584

(22) Filed: Sep. 22, 2023

Related U.S. Application Data
(63) Continuation of application No. PCT/EP2022/057515, filed on Mar. 22, 2022.

(30) Foreign Application Priority Data
Mar. 23, 2021 (DE) 10 2021 107 198.4

(51) Int. Cl. F16K 31/53; B03D 1/24; F16K 1/12; F16K 1/48; F16K 31/02

(52) U.S. Cl. CPC F16K 31/53; B03D 1/24; F16K 1/12; F16K 1/48; F16K 1/126; F16K 31/02

(57) ABSTRACT

A control valve for controlling a gas throughflow having an elongated housing which delimits a flow channel and which is divided into an inflow portion, a drive portion, and an outflow portion. A gear mechanism device has a drive shaft and a round slider element which is arranged in a displaceable manner along the longitudinal axis and which has an external valve seat face which closes an annular gap between itself and an internal face of the outflow portion, and a flow element that faces the inflow portion and has a spherical cap-like external face which directs the gas which comes from the inflow portion into an annular gap between the gear mechanism device and the internal face of the drive portion. A flotation installation having at least one such control valve and the use of such a control valve in a flotation installation are also disclosed.

### CROSS REFERENCES TO RELATED APPLICATIONS

This application is a continuation of international patent application PCT/EP2022/057515 filed on Mar. 22, 2022, which claims priority from German patent application DE 10 2021 107 198 filed on Mar. 23, 2021.

### FIELD

The present invention generally relates to a control valve for controlling a gas throughflow.

### BACKGROUND

A control valve for controlling a gas throughflow is known, for example, from DE 102013110518A1. This control valve is an adjusting slider apparatus having a housing which forms a channel through which a gaseous or fluid medium can flow and at least one longitudinal inlet portion and longitudinal outlet portion, an adjustable control element in order to change the flow cross section of the channel and to adjust the throughflow quantity. The adjusting slider apparatus further has a seat ring element which is provided in the channel. The control element has a first longitudinal portion which has a circular cross section with diameters which vary in a longitudinal direction. The control element is adjustable in a longitudinal direction of the channel along an adjustment path, wherein the control element is located on the seat ring element in a closure position and closes the channel and, in an open position, forms an annular gap which allows throughflow with the seat ring element, and the varying diameters along the first longitudinal portion of the control element are configured in such a manner that the change of the cross sectional surface-area of the annular gap allowing throughflow relative to the adjustment of the control element behaves in a longitudinal direction so that the volume flow through the annular gap behaves virtually linearly relative to the adjustment of the control element along the adjustment path.

This known control valve has been found to be very advantageous in practice. In particular, pressure losses in the control path can be substantially reduced so that energy costs can thereby be saved.

Nevertheless, it has been found that this known control valve cannot be operated in an optimum manner for relatively small pipe diameters, in particular from DN 50 to DN 200.

### SUMMARY

Against this background, an object of the present disclosure is to provide a control valve which, on the one hand, substantially reduces pressure losses in the control path and which, on the other hand, can also be used for relatively small construction sizes from DN 50 to DN 200 in an optimum manner with regard to the control precision. Furthermore, it is also desirable to provide inside the control valve a measurement region which allows a very precise throughflow measurement.

This object is achieved by a control valve having the features of claim 1. The control valve has an elongate housing which delimits a flow channel and which is divided into an inflow portion, a drive portion and an outflow portion which are arranged along a longitudinal axis, wherein the gas flows through the flow channel from the inflow portion via the drive portion to the outflow portion. Inside the drive portion, there is provided a gear mechanism device which has an output shaft, which can be driven from the exterior and which is parallel with the longitudinal axis, and a round slider element which is arranged in a displaceable manner along the longitudinal axis via the output shaft and which has an external valve seat face which closes an annular gap which is defined between itself and an internal face of the outflow portion by longitudinal displacement in a flow direction. Furthermore, there is provided a flow element which is provided on the drive mechanism device at the end thereof facing the inflow portion and which has a spherical-cap-like external face which directs the gas which comes from the inflow portion into an annular gap between the gear mechanism device and the internal face of the drive portion.

The control valve is configured in such a manner that the inflowing, gaseous medium is initially directed via the flow element outwards into a circular-ring-like or annular-gap-like flow channel portion. A region with calm flow which is optimum for a measurement, for example, a throughflow measurement, is thereby produced upstream of the flow element.

The gaseous medium continues to flow through the flow channel portion downstream past the external valve seat face and along the round slider element into the outflow portion. Since the medium flows only in a circular-ring-like flow channel, hardly any flow turbulence is produced so that the pressure losses in the control region of the control valve are small. Furthermore, the round slider element is arranged in such a manner that it closes in the flow direction so that, during closure, it does not have to work against the flow pressure. This allows a substantially smaller drive as a result of the smaller torques which have to be applied but without having to accept losses in the control precision.

The object of the present disclosure is therefore completely achieved.

In a preferred further development, the gear mechanism device has a drive shaft which extends perpendicularly to the output shaft and which is connected thereto via a gear mechanism, wherein one end of the output shaft is located outside the housing and can be connected to a drive device. Preferably, the gear mechanism is in the form of a redirecting gear mechanism, preferably a bevel gear mechanism.

These steps have the advantage that a small gear mechanism device which allows highly precise control behaviour is possible. It is also possible via the gear mechanism to produce very small adjustment paths of the round slider element in a reproducible manner.

In a preferred further development, the round slider element is constructed in a conical manner with a circular base face and a covering face which defines a valve face between the valve seat face, which is preferably in the form of a sealing ring, and the tip of the round slider element, wherein a blind hole which extends parallel with the longitudinal axis is provided at the tip of the round slider element. Preferably, there is provided in the outflow portion, concentrically relative to the longitudinal axis, an annular element which has at least two radially extending spokes which retain a pin which extends parallel with the longitudinal axis, wherein the pin engages in the blind hole in order to support and guide the round slider element.

These steps have been found to be particularly advantageous. In particular, an improvement of the guiding of the round slider element can be achieved via the pin so that the control precision is increased and can be reproduced. As a result of the conical configuration of the round slider element, it is possible to achieve a very good flow path with little turbulence formation.

In a preferred further development, a covering line of the covering face of the round slider element is a non-linear curve and the internal face of the outflow portion has a control contour, wherein the control contour and the valve seat face are adapted to each other in such a manner that the change of the cross section of the annular gap being flowed through between the internal face and the valve seat face is adapted relative to an adjustment path of the round slider element in a longitudinal direction so that a substantially linear operating characteristic line is obtained.

In order to achieve a linear operating characteristic line during operation, there is required a non-linear control valve characteristic line. The inventor has recognized that the dynamic pressure loss increases with increasing throughflow and therefore the control valve has to open the cross section in an over-proportional manner for quantity consistency.

In a more preferable manner, the control contour has at least one control contour end region which is constructed in such a manner that it at least partially supports the valve seat face of the round slider element in a flow direction in the closed state of the control valve and cooperates with it in a sealing manner. More preferably, the control contour has a non-rectilinear extent.

These steps achieve a further optimization of the control behaviour of the control valve.

In a preferred further development, the output shaft is in the form of a spindle, preferably a trapezoidal threaded spindle, and cooperates with a spindle nut, wherein the spindle nut is connected to the round slider element.

This configuration has been found to be particularly advantageous because it allows a reproducible adjustment of the round slider element with very small tolerances.

In a preferred further development, the inflow portion, the drive portion and the outflow portion each have at the longitudinal ends thereof a flange, wherein the portions are releasably connected to each other via the flanges.

This step has the advantage that a high level of flexibility with respect to the installation situations is achieved by dividing the control valve into three. That is to say, in other words, that the control valve can readily be adapted to different circumstances, for example, by inflow portions or outflow portions with different lengths being used. Furthermore, naturally the production and assembly costs can thereby also be reduced.

In a preferred further development, the inflow portion has a cylindrical flow channel which has a constant diameter substantially over the entire longitudinal extent and which widens conically at the transition to the drive portion. Preferably, the drive portion has a flow channel, the diameter of which initially widens conically when viewed in the flow direction and subsequently remains substantially constant. In a more preferable manner, the flow channel has in the drive portion at least partially two mutually separate circular-ring-segment-like channels. In a more preferable manner, the outflow portion has in an upstream region a circular-ring-like flow channel, the diameter of which in the flow direction initially corresponds to the diameter of the adjacent drive portion and subsequently tapers conically to a diameter which substantially corresponds to the diameter of the inflow portion, wherein the circular-ring-like flow channel merges into a circular flow channel.

These configurations of the different portions of the flow channel have been found to be particularly advantageous in order, on the one hand, to obtain a measurement region with calm flow in the inflow portion and, on the other hand, to achieve a reproducible flow with little turbulence and with small pressure losses over the entire control valve length.

In a preferred further development, at least one opening is provided in the inflow portion for introducing at least one measuring element, preferably a throughflow measuring element. In a more preferable manner, a flow modulating element, preferably a perforated disc, is provided in the inflow portion at the downstream end.

This step has the advantage that a measuring element can be introduced into the control valve in a simple manner. Furthermore, it is possible to further optimize the flow by the flow modulating element in order to achieve particularly good measurement results.

The drive device is preferably in the form of a pneumatic drive device, hydraulic drive device or electric drive device.

In a preferred further development, the control valve has such dimensions that it can be used in a pipeline having a nominal width between DN50 and DN200.

In the case of these relatively small pipe diameters, it is possible to particularly readily use the control valve according to the present disclosure.

The control valve can be used particularly advantageously as a control valve in a flotation installation for controlling the gas supply flow, that is to say, the gas quantity, in a plurality of tanks of the flotation installation. Particularly during this use, very high energy saving effects can be achieved over previous solutions. If flotation installations are provided with the control valve according to the present disclosure instead of with the previous control valves, a substantially more economical operation can be achieved. Furthermore, the flotation process is substantially improved by the high control precision and the installation power is increased.

The problems with flotation installations with regard to the control of the air quantity involves, firstly, a plurality of tanks being supplied with air via a common compressor (via a common pipeline system) and, secondly, the relationships in the tanks being different and further being able to change dynamically. For example, the fluid levels in the tanks are different so that the air has to be introduced against different static pressures (with the air quantity being kept constant). The density of the liquids in the tanks can also change so that the static pressures also change in this instance. Without any control valves in the lines to the tanks which can react rapidly and precisely to such pressure changes in order to keep the air quantity in the tanks constant despite variable pressure, the air quantity which is introduced into a tank would change constantly. It is clear that the flotation process itself is thereby impaired.

It will be understood that the above-mentioned features and those which will be explained below can be used not only in the combination set out but also in other combinations or alone without departing from the scope of the present invention.

### DESCRIPTION OF FIGURES

Additional advantages and embodiments will be appreciated from the description and the appended drawings. In the drawings:

FIG. 1 shows a side view of the control valve according to the present disclosure with a drive device;

FIG. 2 shows a sectioned side view of the control valve in the open state;

FIG. 3 shows a sectioned side view of the control valve in the closed state, wherein the view is illustrated in a state rotated through 90° with respect to the view of FIG. 2;

FIG. 4 shows a sectioned view along the line A-A from FIG. 2;

FIG. 5 shows a sectioned view along the line B-B and a sectioned view along the line C-C of FIG. 2; and

FIG. 6 shows a perspective view of the control valve according to the present disclosure, wherein the outflow portion is illustrated in an offset manner.

### DESCRIPTION OF PREFERRED EMBODIMENTS

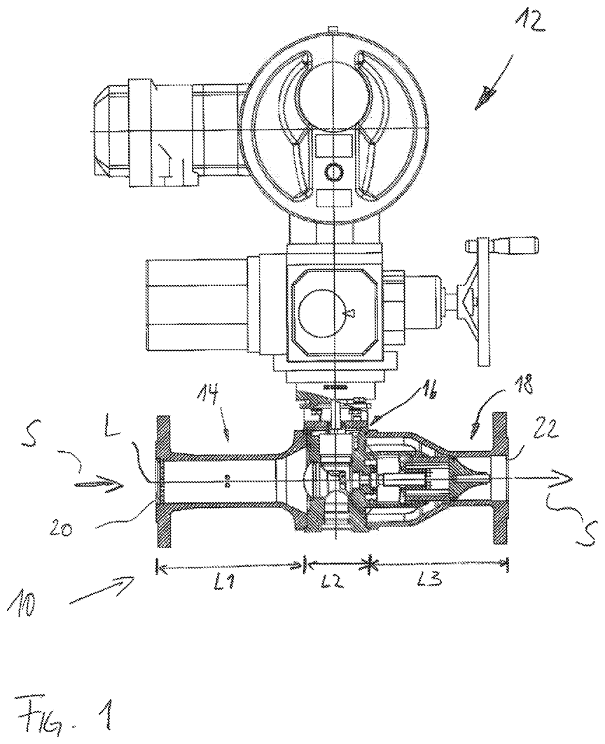

FIG. 1 illustrates a control valve according to the present disclosure and is designated 10 in a sectioned view. The control valve is particularly used to control the throughflow quantity of a gaseous medium, preferably air, for example, in a flotation installation. The control valve 10 is configured in such a manner that it can be installed subsequently in existing pipeline systems.

The control valve 10 is releasably connected to a drive device 12 which is used for opening and closing the control valve 10 in a controlled manner. Depending on the application, the drive device 12 may have an electric drive, a pneumatic drive or a hydraulic drive. Since the drive device 12 is a known component, it is not intended to be discussed any further. An important aspect is, however, that the drive device 12 is releasably fitted to the control valve so that an exchange is possible at all times.

The control valve 10 is divided into three portions, that is to say, an inflow portion 14 with a length L1, a drive portion 16 with a length L2 and an outflow portion 18 with a length L3. The three portions 14, 16 and 18 form independent subassemblies which are releasably connected to each other and which are therefore also exchangeable at all times. For example, it would be conceivable to construct the inflow portion 14 to have a different length depending on the application.

As can be seen in FIG. 1, the three portions 14, 16 and 18 are arranged along a longitudinal axis L so that a virtually rectilinear flow extent is produced by the control valve That is to say, in other words, that an inflow opening 20 of the control valve 10 is located concentrically relative to an outflow opening 22.

The flow direction of the gaseous medium is indicated in FIG. 1 by the arrows S. The gaseous medium flows through the inflow opening 20 into the control valve 10 and leaves it through the outlet opening 22. At this point, it may be noted that the control valve can be used advantageously only in this manner. Or, in other words, if the gaseous medium were to flow in the opposite direction through the control valve 10, the above-mentioned advantages would not be able to be achieved. The throughflow direction of the control valve 10 is consequently highly significant unlike in other control valves.

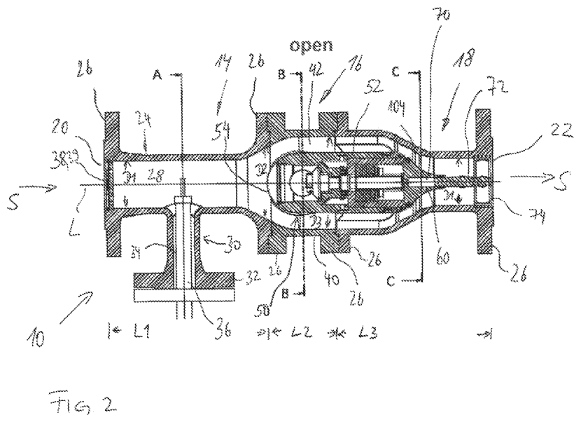

The precise construction of the control valve 10 is intended to be explained in greater detail below with reference to FIGS. 2 to 5.

FIG. 2 illustrates the control valve 10 from FIG. 1 to an enlarged scale, but with the plane of section having been rotated through 90°.

The inflow portion 14 has a tubular housing 24 which has a flange 26 at both ends. The tubular housing 24 forms a cylindrical flow channel 28 with an internal diameter D1 in the region of the inflow opening 20. The internal diameter of the flow channel 28 remains constant over virtually the entire length L1, but then expands, when viewed in the flow direction, to an internal diameter D2. The length L1 is preferably approximately 200 mm.

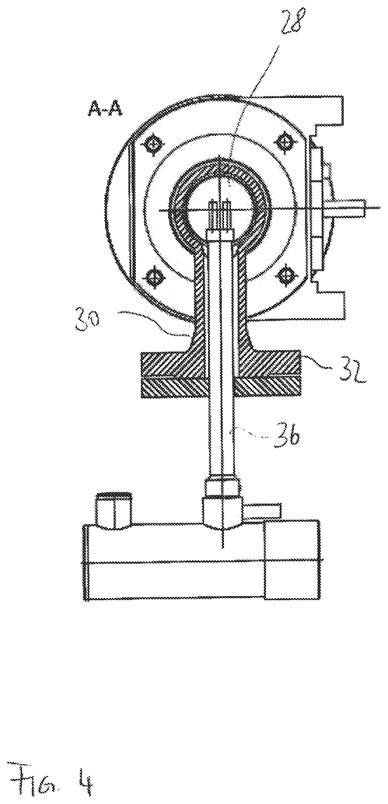

As can be seen in FIG. 2, the housing 24 has a tubular branch 30 (with a circular or oval cross section) which extends outwards at right-angles to the longitudinal axis L at approximately half of the length of the inflow portion 14. The branch 30 terminates in a flange 32. The branch 30 consequently forms a channel 34 which provides a connection from the exterior into the flow channel 28. Consequently, it is possible via this channel 34 to introduce a measuring instrument, in particular a throughflow measuring instrument 36, into the flow channel 28. FIG. 4 illustrates the branch 30 even more clearly. In particular, it can be seen here that the measuring instrument has two sensor tips which are positioned at the centre of the flow channel. It has been found to be particularly advantageous to arrange the sensor tips when viewed in a longitudinal direction approximately 100 mm away from the downstream end of the inflow portion.

As a result of the particular configuration of the control valve 10, it is possible to achieve a very homogeneous flow in the flow channel 28 so that the measurement is very advantageous precisely in this region. The measurement results are very precise and reproducible.

Depending on the application, including to improve the measurement, in the region of the inflow opening 20 a flow modulating element 38 can be provided. Preferably, a perforated disc 39 is used to this end. The flow modulating element 38 can also be used to selectively reduce the pressure in connected control circuits at different pressures for a common gas supply. In this manner, for example, the noise level and the control valve wear can be reduced and the control quality can be increased.

The drive portion 16 which also has a tubular housing 40 which is also delimited by two flanges 26 in a longitudinal direction adjoins the inflow portion 14. The inflow portion 14 and drive portion 16 are releasably connected to each other in a gas-tight manner via the adjoining flanges 26. The inflow opening of the drive portion 16 is of the same size as the outflow opening of the inflow portion 14 and consequently has an internal diameter D2.

The housing 40 forms a flow channel 42 which expands—when viewed in the flow direction—from the internal diameter D2 to a larger internal diameter D3. As can be seen in FIG. 2, the larger length of the drive portion 16 has the internal diameter D3. In particular, the outflow opening of the drive portion 16 has the internal diameter D3.

A gear mechanism device 50 which has all the components necessary to control the gas throughflow is located in the housing 40 and in a state retained thereby. These components which will be discussed in detail below are surrounded by a flow-optimized housing 52 or a housing covering which is preferably arranged centrally relative to the longitudinal axis L in the flow channel 42. At this point, it may further be noted that the housing 52 is securely connected to the housing 40 of the drive portion 16, but extends out of the drive portion 16 into the adjacent outflow portion 18. This means that, in other words, the two portions 16, 18 remain releasable from each other although a portion of the housing 52 is located in the outflow portion 18.

As already mentioned, the housing 52 is constructed in a flow-optimized manner so that the gaseous medium can flow through the flow channel 42 with as little resistance as possible. To this end, the housing 52 has a spherical-cap-like flow element 54 at the upstream end thereof which faces the inflow portion 14. The flow element 54 has the function of directing the inflowing gas outwards into the flow channel 42. At this point, it may be noted that the flow channel 42 is constructed at the upstream end of the drive portion 16 in a circular-ring-like manner. That is to say, in other words, that the centre of the flow channel 42 is occupied by the housing 52.

The flow element 54 with the convex shape thereof has a decisive influence on the flow in the inflow portion 14 and therefore also on the measurement results which can be obtained at that location. The flow element 54 acts as an integrated flow modulator and therefore stabilizes the flow profile in the inflow portion 14.

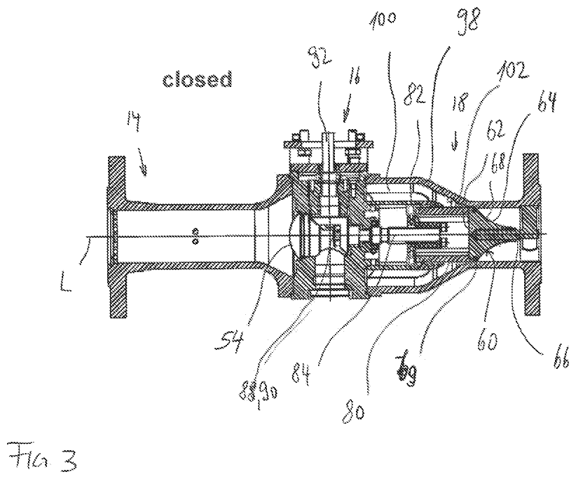

A control element which is in the form of a round slider element 60 is provided at the downstream end, facing the outlet opening 22, of the housing 52. FIG. 2 shows this round slider element 60 in a completely open position and FIG. 3 shows it in a completely closed position. The round slider element 60 is arranged in the housing 52 in a manner displaceable in the longitudinal direction so that by displacing the round slider element 60 the cross sectional surface-area of the flow channel being subjected to flow can be changed.

The round slider element 60 has a frustoconical shape with a circular base face 62, as shown in FIG. 3, and a covering face 64 which extends from the base face 62 to a tip 66. The covering face 64 has a non-rectilinear covering line 68. From the base face 62, the diameter of the round slider element 60—when viewed in a longitudinal direction—reduces initially powerfully in order to subsequently change only very little at the tip 66.

In the region of the base face 62, a sealing ring 69 which forms a valve seat face of the round slider element 60 is provided. As can be seen in FIG. 3, the round slider element is arranged concentrically relative to the longitudinal axis L. The sealing ring 69, that is to say, the valve seat face, forms with the radially opposite internal face of the outflow portion 18 the flow cross section which is changed in order to control the throughflow quantity.

At the tip 66 of the round slider element 60, a hole 70 which is in the form of a blind hole is provided. The hole 70 extends along the longitudinal axis and axis of symmetry of the round slider element 60.

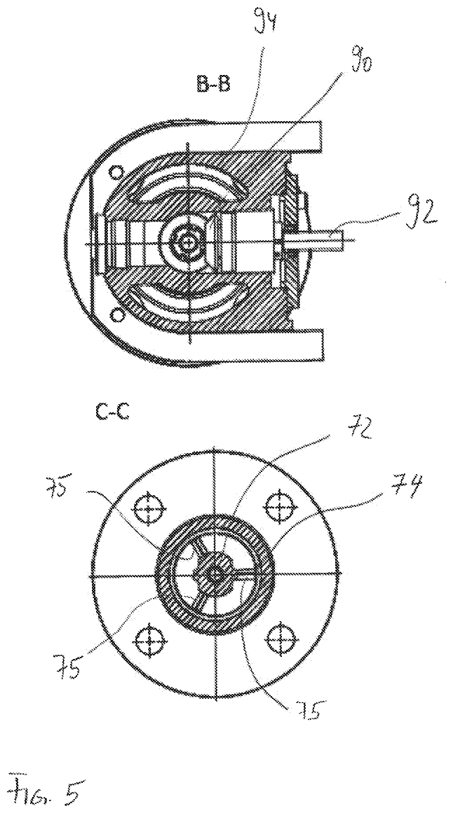

The hole 70 is constructed to receive a pin 72. The pin 72 is arranged in a manner fixed in position relative to the outflow portion 18 on an annular element 74, as shown, for example, in FIG. 5, which is in turn arranged in the region of the outflow opening 22 of the outflow portion 18. The annular element 74 has an external ring with spokes 75 which extend therefrom and which retain the pin 74 at one of the two ends thereof. Preferably, at least three spokes are provided. The other end of the pin 74 projects into the hole 70 so that the round slider element 60 in the region of the tip 66 thereof is retained, on the one hand, and, on the other hand, is guided when the round slider element 60 moves in a longitudinal direction.

With reference to FIG. 3, a bush-like element 80 is provided in the region of the base face 62 of the round slider element 60. It is securely connected to the base face 62. There is arranged inside the element 80 a spindle nut 82 which cooperates with a threaded spindle 84. The threaded spindle 84 is arranged concentrically inside the housing 52 relative to the longitudinal axis L and acts as an output shaft.

The threaded spindle 84 or the output shaft is connected at the downstream end thereof to a gear mechanism 88 which is preferably in the form of a bevel gear mechanism 90. The gear mechanism 88 serves to transmit energy which is introduced via a drive shaft 92 to the output shaft. The drive shaft 92 extends perpendicularly to the longitudinal axis L in the drive portion 16 into the housing 54. The gear mechanism 88 consequently converts the rotational movement about the axis perpendicular to the longitudinal axis L into a rotational movement about the longitudinal axis L.

As can be seen from a comparison of FIGS. 2 and 3, the drive shaft 92 also extends through a portion of the flow channel 42 so that it is thereby blocked at least partially. The sectioned view along the line B-B from FIG. 2 which is shown in FIG. 5 explains that in this region the flow channel comprises two mutually separate circular-ring-segment-like openings 94.

The drive shaft 92 is connected to the drive device 12, in particular releasably connected, so that the drive device 12 can be changed without simultaneously changing the gear mechanism 88.

The outflow portion 18 has, as also do the other two portions 12, 14, a tubular housing 98, as shown in FIG. 3, which has a flange 26 at each of the two ends thereof. The housing 98 is connected to the drive portion 16 via the flange 26 in a gas-tight manner, wherein the internal diameter of the inflow opening of the outflow portion 18 corresponds to the diameter D3 of the drive portion 16.

The housing 98 forms a flow channel 100 which tapers when viewed in the flow direction. The internal diameter of the flow channel 100 reduces from the internal diameter D3 to the internal diameter D1 at the outflow opening 22.

As already explained, the housing 52 of the gear mechanism device 50 extends into the flow channel 100 of the outflow portion 18 so that only a circular-ring-like cross section is thereby available for the flow.

In the region of the transition from the internal diameter D3 to the internal diameter D1, the internal face of the flow channel 100 has a control contour 102 which also determines the control behaviour of the control valve. As can be seen in FIGS. 2 and 3, during the displacement of the round slider element 60 in a longitudinal direction the cross section between the sealing ring 69 and the internal face of the flow channel is changed. In the completely open state of the control valve 10, as shown in FIG. 2, the cross section or the cross sectional surface-area is at a maximum. In the completely closed state of the control valve 10, as shown in FIG. 3, the cross sectional surface-area is zero, that is to say, the sealing ring 69 abuts the internal face in a sealing manner. In that the round slider element is adjusted in a longitudinal direction, it is possible to obtain a relatively great stroke, which allows a very precise control. Or, in other words, the great stroke allows a high resolution of the adjustment of different opening cross sections of the control valve.

As already mentioned above, the round slider element 60 has a non-rectilinear covering line 68. This covering line is selected so that the cross sectional surface-area of the flow channel increases rapidly after the sealing ring 69. Furthermore, non-uniformities 104 may be provided in the control contour 102 in order to be able to adapt the control behaviour to specific circumstances. In particular, a linear operating characteristic line can be achieved by selecting the control contour 102.

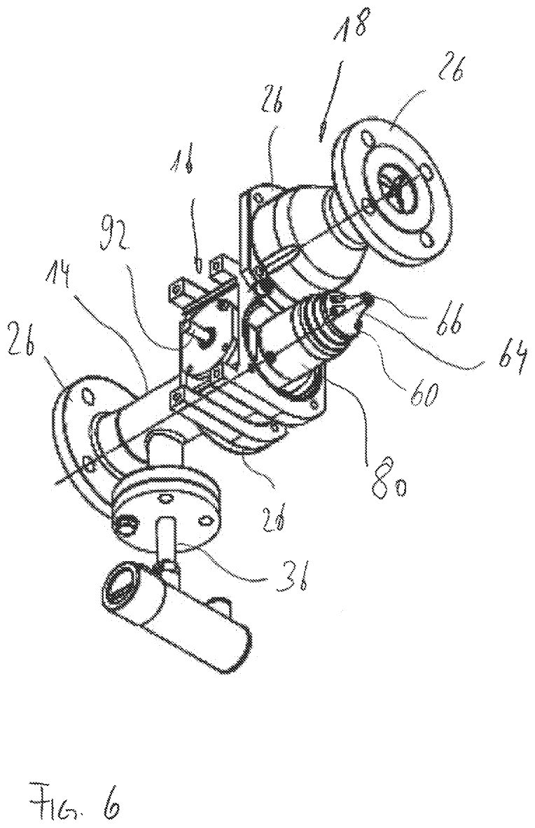

FIG. 6 again shows the control valve 10 as a perspective view, wherein the outflow portion 18 is released from the drive portion 16 and in particular releases the round slider element 60. The special shape of the covering face 64 of the round slider element 60 with the non-rectilinear covering line can be clearly seen. Furthermore, the bush-like element 80 which is connected to the round slider element is shown. Otherwise, identical parts to those in the preceding Figures are denoted with the same reference numerals.

The operation of the control valve 10 is as follows:

The control valve 10 can be installed in an existing pipeline system, wherein the flow direction must be observed because the control valve 10 can be advantageously used only in one direction. The control valve 10 is specifically configured for nominal widths from DN50 to DN200. For relatively large nominal widths, it is possible to better use other valves, in particular the modulating slider valve mentioned in the introduction to the description.

The gas which flows through the inflow opening 20 passes through the flow channel 28 and is guided at the end of the inflow portion 14 from the flow element 54 into the external annular region of the flow channel 42. As a result of the special shape of the flow element 54, particularly at the centre (when viewed in the radial direction) of the flow channel 28, at locations where the throughflow measuring instrument is provided, a reproducible flow profile is produced.

The gas which is redirected by the flow element 52 flows along the internal face of the flow channel 42, that is to say, between the housing 40 and the housing 52 through the two circular-ring-segment-like openings 54 into the flow channel 100 of the outflow portion 18. This region of the flow channel 100 is circular-ring-like as far as the outflow opening 22, wherein the cross sectional surface-area of the flow channel increases, preferably in a non-linear manner, constantly from the sealing ring 69 up to the tip of the round slider element 60. The Venturi effect which occurs in this region contributes substantially to the small energy losses of the control valve 10.

If the throughflow quantity of the gas is intended to be reduced, the round slider element 60 is displaced via the drive device 12 in the flow direction so that, as a result of the control contour 102, the cross sectional surface-area subjected to flow is preferably reduced linearly with the adjustment path. Via the throughflow measuring instrument 36, the throughflow quantity can be detected in a stable manner in order thus to be able to adjust and retain the desired throughflow quantity by means of a control device which is not shown.

It is important to mention at this point that, with correct installation of the control valve 10, the round slider element 60 does not have to work counter to the pressure of the inflowing gas during closing. Instead, the control valve 10 is closed by displacing the round slider element 60 in the flow direction. This configuration allows smaller torques so that the components of the gear mechanism device 50 can be configured to be smaller.

In order to further optimize the flow behaviour in the region of the round slider element 60, the guide is provided by the pin 72. This guide avoids, for example, tilting of the round slider element 60 with respect to the longitudinal axis, which would lead to occurrences of asymmetry in the flow channel.

Overall, the control valve 10 according to the present disclosure allows a particularly precise reproducible control of the throughflow quantity of a gas specifically for pipeline systems with a nominal width from DN50 to DN200.

One advantageous possible area of use of this control valve 10 may be seen in so-called flotation installations. Such flotation installations use the introduction of air into large fluid tanks to separate solids, for example, ore. The control valve 10 according to the present disclosure can now be very readily used in existing pipeline systems of such flotation installations. The energy consumption for introducing the air can thus be substantially reduced over previous systems. It is further possible to control the supplied air quantity into the tanks of the installation very precisely even if the pressure relationships in the tanks change dynamically. This consistency in the supplied air quantity is highly significant with regard to the processes in the tanks.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. Control A control valve for controlling a gas throughflow, having:
an elongate housing which delimits a flow channel and which is divided into an inflow portion, a drive portion and an outflow portion which are arranged beside each other along a longitudinal axis, wherein the gas flows—during operational use of the control valve—through the flow channel from the inflow portion via the drive portion to the outflow portion,
a gear mechanism device which is provided inside the drive portion and which has a drive shaft, which can be driven from the exterior and which is parallel with the longitudinal axis, and a round slider element which is arranged in a displaceable manner along the longitudinal axis via the output shaft and which has an external valve seat face which closes an annular gap which is defined between itself and an internal face of the outflow portion by longitudinal displacement in a flow direction, and
a flow element which is provided on the drive mechanism device at the end thereof facing the inflow portion and which has a spherical-cap-like external face which directs the gas which comes from the inflow portion into an annular gap between the gear mechanism device and the internal face of the drive portion.

2. The control valve according to claim 1, wherein the gear mechanism device has a drive shaft which extends perpendicularly to the output shaft and which is connected thereto via a gear mechanism, wherein one end of the output shaft is located outside the housing and can be connected to a drive device.

3. The control valve according to claim 2, wherein the gear mechanism is in the form of a redirecting gear mechanism, preferably a bevel gear mechanism.

4. The control valve according to claim 1, wherein the round slider element is constructed in a conical manner with a circular base face and a covering face which is provided between the valve seat face, which is preferably in the form of a sealing ring, and the tip of the round slider element, wherein a blind hole which extends parallel with the longitudinal axis is provided at the tip of the round slider element.

5. The control valve according to claim 4, wherein there is provided in the outflow portion, concentrically relative to the longitudinal axis, an annular element which has at least two radially extending spokes which retain a pin which extends parallel with the longitudinal axis, wherein the pin engages in the blind hole in order to support and guide the round slider element.

6. The control valve according to claim 4, wherein a covering line of the covering face of the round slider element is a non-linear curve and the internal face of the outflow portion has a control contour, and the control contour and the valve seat face are adapted to each other in such a manner that the change of the cross section of the annular gap being flowed through between the internal face and the valve seat face is adapted relative to an adjustment path of the round slider element in a longitudinal direction so that a substantially linear operating characteristic line is obtained.

7. The control valve according to claim 6, wherein the control contour has at least one control contour end region which is constructed in such a manner that it at least partially supports the valve seat face of the round slider element in a flow direction in the closed state of the control valve and cooperates with it in a sealing manner.

8. The control valve according to claim 7, wherein the control contour has a non-rectilinear extent.

9. The control valve according to claim 1, wherein the output shaft is in the form of a spindle, preferably a trapezoidal threaded spindle, and cooperates with a spindle nut, wherein the spindle nut is connected to the round slider element.

10. The control valve according to claim 1, wherein the gear mechanism device has a gear mechanism covering which has a flow-optimized external face, wherein the gear mechanism covering surrounds both the drive shaft and the output shaft.

11. The control valve according to claim 1, wherein the inflow portion, the drive portion and the outflow portion each have at the longitudinal ends thereof a flange and are releasably connected to each other via the flange.

12. The control valve according to claim 1, wherein the inflow portion has a cylindrical flow channel which has a constant diameter substantially over the entire longitudinal extent and which widens conically at the transition to the drive portion.

13. The control valve according to claim 12, wherein the drive portion has a flow channel, the diameter of which initially widens conically when viewed in the flow direction and subsequently remains substantially constant.

14. The control valve according to claim 13, wherein the flow channel has in the drive portion at least partially two mutually separate circular-ring-segment-like channels.

15. The control valve according to claim 11, wherein the outflow portion has in an upstream region a circular-ring-like flow channel, the diameter of which in the flow direction initially corresponds to the diameter of the adjacent drive portion and subsequently tapers conically to a diameter which substantially corresponds to the diameter of the inflow portion, wherein the circular-ring-like flow channel merges into a circular flow channel.

16. The control valve according to claim 6, wherein the control contour is located in the conically tapering region of the outflow portion.

17. The control valve according to claim 1, wherein at least one opening is provided in the inflow portion for introducing at least one measuring element, preferably a throughflow measuring element.

18. The control valve according to claim 12, wherein a flow modulating element, preferably a perforated disc, is provided in the inflow portion at the downstream end.

19. The control valve according to claim 2, wherein the drive device is in the form of a hydraulic drive device or pneumatic drive device.

20. The control valve according to claim 2, wherein the drive device is in the form of an electric drive device.

21. The control valve according to claim 1, wherein it has such dimensions that it can be used in a pipeline having a nominal width between DN50 and DN200.

22. Floatation A floatation installation for separating solids, in particular ore, having a plurality of tanks and at least one line for supplying gas to each tank, wherein a control valve according to claim 1 is provided in the line to a respective tank in order to control the gas flow into each tank.

23. Use of a control valve according to claim 1 in a flotation installation in order to control the gas inflow into a tank of the flotation installation.
